(19) United States
(12) Patent Application Publication
(10) Pub. No.: US 2010/0283388 A1
(43) Pub. Date: Nov. 11, 2010

(54) ELECTRODE PASTE FOR PLASMA DISPLAY PANEL AND BLACK BUS ELECTRODE FOR PLASMA DISPLAY PANEL

(75) Inventors: Kazushige Ito, Yokohama (JP); Ji-Yeon Lee, Kanakawa-ken (KR); Hisashi Matsuno, Tokyo (JP); Yong-Woo Cho, Tochigi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/841,488

(22) Filed: Jul. 22, 2010

Related U.S. Application Data
(63) Continuation of application No. 11/890,856, filed on Aug. 8, 2007.

(51) Int. Cl. H01J 61/04; H01B 1/08

(52) U.S. Cl. 313/633; 252/514; 252/512

(57) ABSTRACT

Described is an electrode paste for plasma display panel, which has a black pigment, a glass frit, an organic binder and a solvent, wherein the black pigment contains cobalt oxide (CO₃O₄) and copper-chromium-cobalt composite oxide (Cr—Cu—Co—O).

This application is a continuation of Ser. No. 11/890,856, filed on Aug. 8, 2007.

### BACKGROUND OF THE INVENTION

1. Field of the Invention

The present invention relates to an electrode paste for plasma display panel (PDP) and to the PDP. More particularly, the present invention relates to the improvement of the black components in the electrode.

2. Technical Background

In a PDP, a bus electrode on a front panel of the PDP contains a black component in order to improve contrast. A single-layer bus electrode and a two-layer bus electrode are known as the bus electrodes. The single-layer bus electrode contains a conductive component, such as silver, and a black component. In the two-layer bus electrode, a white electrode containing a conductive component, such as silver, and a black component are laminated.

Ruthenium oxide, ruthenium compound (U.S. Pat. No. 5,851,732), CO₃O₄ (Japanese Patent 3854753), Cr—Cu—Co (U.S. Patent Publication 2006-0216529), lanthanum compound (Japanese Patent 3548146), and Cuo-Cr₂O₃—Mn₂O₃ (U.S. Pat. No. 6,555,594) are known as the black components.

In order to improve contrast in the PDP, it is preferred that the blackness of the black component be high. In the PDP, the blackness is normally rated as an L-value. When considering the power consumption, however, it is necessary to minimize the increase of a resistance value, the increase being caused by adding the black component. If, generally, the amount of the black components is increased, the blackness increases and thereby the resistance value also tends to increase. Therefore, it is desirable to use a material having high blackness and a low resistance value.

The present invention provides a black electrode having high blackness and a low resistance value, and thereby improves upon the characteristics of a PDP.

### SUMMARY OF THE INVENTION

The present invention is an electrode paste for plasma display panel, which has a black pigment, a glass frit, an organic binder and a solvent, wherein the black pigment contains cobalt oxide (CO₃O₄) and copper-chromium-cobalt composite oxide (Cr—Cu—Co—O).

In the electrode paste of the present invention, the content of the copper-chromium-cobalt composite oxide is 45 wt %-90 wt % and is preferably 50 wt %-85 wt % based on the total amount of the cobalt oxide and copper-chromium cobalt composite oxide. The electrode paste of the present invention can further contain conductive particles.

The present invention also includes a bus electrode for plasma display panel. A first embodiment of the bus electrode of the present invention is a bus electrode for plasma display panel, which is formed on a front panel of the plasma display panel, wherein the bus electrode has a black/white two-layer structure comprising a black electrode and a white electrode, and the black electrode contains cobalt oxide (Co₃O₄) and copper-chromium cobalt composite oxide (Cr—Cu—Co—O) as the black pigment.

A second embodiment of the bus electrode of the present invention is a bus electrode for plasma display panel, which is formed on a front panel of the plasma display panel, wherein the bus electrode comprises a black single-layer bus electrode, and the black single-layer bus electrode contains cobalt oxide (Co₃O₄) and copper-chromium cobalt composite oxide (Cr—Cu—Co—O) as the black pigment.

The content of the copper-chromium cobalt composite oxide, which is the black pigment contained in the bus electrode, is 45 wt %-90 wt % and is preferably 50 wt %-85 wt % based on the total amount of the cobalt oxide and copper-chromium cobalt composite oxide.

A black electrode having high blackness and a low resistance value is formed by using the electrode paste of the present invention. Furthermore, the PDP of the present invention has excellent contrast due to the high blackness of the black electrode, and has low power consumption due to the low resistance value of the black electrode.

### BRIEF DESCRIPTION OF THE DRAWINGS

FIG. 1 is an expanded perspective view schematically showing an alternating-current plasma display panel device created according to the present invention;

FIG. 2 is an explanatory diagram showing a series of steps of a method for creating two layers of bus electrodes on a glass substrate having transparent electrodes, wherein 2A shows a stage where an electrode paste layer for forming a black electrode is applied, 2B shows a stage where a bus conductor paste for forming a white electrode is applied, 2C shows a stage where the abovementioned paste is exposed to light to define an electrode pattern, 2D shows a stage of development, and 2E shows a stage of firing;

FIG. 3 is an explanatory diagram showing a series of steps of the method for creating two layers of bus electrodes on a glass substrate having transparent electrodes, wherein 3A shows a stage where the transparent electrodes are formed on the substrate, 3B shows a stage where the electrode paste layer for forming a black electrode is applied, 3C shows a stage where the abovementioned paste layer is exposed to light to define an electrode pattern, 3D is a stage of development, and 3E is a stage of firing, 3A through 3E corresponding to the explanatory diagram showing a series of steps of the method for creating two layers of bus electrodes on a glass substrate having transparent electrodes; FIG. 3F-3I continues the explanatory diagram showing a series of steps describing the method for creating two layers of bus electrodes on a glass substrate having transparent electrodes. FIG. 3F shows a stage where a bus conductor paste layer 7 for forming a white electrode is formed and then dried, 3G shows a stage where the bus conductor paste layer is exposed to light imagewise to define an electrode pattern, 3H shows a stage of development, and 3I shows a stage of firing.

### DETAILED DESCRIPTION OF THE INVENTION

A first aspect of the present invention is an electrode paste for plasma display panel, which has a black pigment, a glass frit, an organic binder and a solvent, wherein the black pigment contains cobalt oxide (CO₃O₄) and copper-chromium-cobalt composite oxide (Cr—Cu—Co—O).

The components of a light-forming black electrode of the present invention are described hereinafter.

### (A) Black Pigment of Electrode Paste

The black pigment of the electrode paste of the present invention contains cobalt oxide (CO₃O₄) and copper-chromium-cobalt composite oxide (Cr—Cu—Co—O). The content of the copper-chromium-cobalt composite oxide is 45 through 90 wt % and is preferably 50 through 85 wt % based on the total amount of the cobalt oxide and copper-chromium-cobalt composite oxide.

The black pigment of the electrode paste is used at a rate of 4 wt % to 50 wt %, preferably 6 wt % to 30 wt %, more preferably 5 wt % to 15 wt %, and most preferably 9 t % to 12 wt % on the basis of the weight of the whole compositions including an organic medium.

### (B) Conductive Metal Particles of Electrode Paste

The electrode paste of the present invention can optionally contain precious metals including gold, silver, platinum, palladium, copper and combinations thereof. Particularly when using the electrode paste of the present invention as a black single-layer electrode, the above mentioned metals are contained in the electrode paste.

Virtually, any form of metal powder, including spherical particles and flakes (rods, cones, and plates), can be used in the paste of the present invention. Preferred metal powder is selected from the group consisting of gold, silver, palladium, platinum, copper and combinations thereof. It is preferred that the particles be spherical.

It has been found that the conductive paste ought not to contain a significant amount of conductive metal solids having a particle diameter of less than 0.2 μm. When such small particles are present, it is difficult to adequately perform complete combustion of the organic medium when the films or layers thereof are fired to remove the organic medium. It is also difficult to sinter an inorganic binder and the metal solids. When the electrode paste of the present invention is used to create thick film pastes that are usually applied by screen printing, the maximum particle diameter is preferred not to exceed the thickness of the screen. It is preferred that at least 80 wt % of the conductive solids fall within the range of a particle diameter between 0.5 μm and 10 μm.

In addition, preferably the ratio between the surface area and the weight of an optionally selected conductive metal particle does not exceed 20 m²/g, more preferably does not exceed 10 m²/g, and most preferably does not exceed 5 m²/g. When using a metal particle in which the ratio between the surface area and the weight is greater than 20 m²/g, the sintering characteristics of the accompanying inorganic binder are sometimes adversely affected. It may be difficult to perform adequate combustion, and blisters may appear.

Although not required, copper oxide is often added to the paste to improve adhesion. The copper oxide is preferred to be present in the form of fine particles having a particle diameter from, preferably, approximately 0.1 through 5 microns. When present as Cu₂O, the copper oxide constitutes approximately 0.1 through approximately 3 wt % of the entire paste, and preferably constitutes approximately 0.1 through 1.0 wt %. Part or all of the Cu₂O may be replaced by molar equivalents of CuO.

### (C) Glass Frit

The glass frit used in the present invention assists in sintering the conductive component particles. If the softening point of the glass frit is lower than the melting point of the conductive components, such glass frit can be used in any paste known in this field. The softening point of the glass frit has great influence on the sintering temperature. The glass softening point for sufficiently sintering the electrode paste of the present invention on a layer there below is preferably approximately 325° C. through 700° C., more preferably approximately 350° C. through 650° C., and still more preferably approximately 375° C. through 600° C.

When melting occurs at a temperature lower than 325° C., organic materials may be easily wrapped, and blisters are easily generated in the paste as the organic materials are decomposed. On the other hand, when the softening point exceeds 700° C., the viscosity of the paste may easily deteriorate.

The glass frit to be used is, most preferably, borosilicate frit having zinc, bismuth, cadmium, barium, calcium, or other alkaline earth metal. The method for preparing such glass frit is known, and there is, for example, a method for melting the glass components in a state of oxide thereof and feeding the molten paste into water to obtain a frit. Of course, any compound for generating a desired oxide under the ordinary frit manufacturing conditions can be used as the batch component. For example, boron oxide can be obtained from boric acid, silicon dioxide can be obtained from flint, and barium oxide can be obtained from barium carbonate.

Furthermore, a lead-free and cadmium-free Bi based amorphous glass, or a lead-free and low-melting glass such as P based or Zn—B based compositions can be used as the glass frit. However, P based glass does not have good water resistance, and it is difficult to obtain Zn—B glass in the amorphous state, thus Bi based glasses are preferred. Bi glass can be created to have a relatively low melting point without adding an alkali metal, and problems rarely arise when creating glass powder. Such Bi-based glass is disclosed in, for example, Japanese Patent Application No. 2006-339139.

It is preferred that Solid paste not be agglutinated. The frit is passed through a fine sieve to remove large particles. The ratio between the surface area and the weight of the glass frit is preferred to be 10 m²/g or less. At least 90 wt % of the particles preferably has a particle diameter of 0.4 μm through 10 μm.

The weight percent of the glass frit is preferably 0.01 through 25 wt % of the solid content of the electrode paste. If the proportion of the glass frit is high, the connectivity to the substrate becomes low.

### (D) Organic Binder

The organic binder is an important element in the paste of the present invention. The water-based development possibility is preferably taken into consideration when selecting the organic binder, and an organic binder with high resolution must be selected. The following organic binders satisfy these requirements. Specifically, these organic binders are copolymers or inter-polymers (composite polymers) that are prepared from (1) a non-acidic comonomer containing C₁ through C₁₀ alkyl acrylate, C₁ through C₁₀ alkyl methacrylate, styrene, substituted styrene, or a combination thereof, and (2) an acidic comonomer in an amount of at least 15 wt % of the total weight of the polymer and having a component containing an ethylenically unsaturated carboxylic acid.

The presence of the acidic comonomer component in the electrode paste is important to the technology of the present invention. Depending on its acidic functional group, development can be performed in an aqueous base, such as an aqueous solution containing 0.8% of sodium carbonate. If the content of the acidic comonomer is less than 15%, the electrode paste is not completely scoured by the aqueous base. If the content of the acidic comonomer is more than 30%, the stability of the paste becomes deteriorated under the development conditions, and only partial development is performed in an image formation part. Examples of proper acidic comonomers include ethylenically unsaturated monocarboxylic acids such as acrylic acid, methacrylic acid and crotonic acid, ethylenically unsaturated dicarboxylic acids such as fumaric acid, itaconic acid, citraconic acid, vinyl succinic acid and maleic acid, hemiesters thereof, and, in some cases, anhydrides and mixtures thereof. Methacryl polymers are more preferred than acryl polymers since they combust more cleanly in a low-oxygen atmosphere.

When the above mentioned non-acidic comonomer is the alkyl acrylate or alkyl methacrylate, it is preferred that such non-acidic comonomer constitute at least 50 wt %, preferably 70 through 75 wt %, of polymeric binder. If the non-acidic comonomer is styrene or substituted styrene, it is preferred that such non-acidic comonomer constitute 50 wt % of the polymeric binder, while the other 50 wt % be an acidic anhydride, such as the hemiester of maleic anhydride. The preferred substituted styrene is α-methylstyrene.

Although not preferred, the non-acidic part of the polymeric binder can contain approximately 50 wt % or less of another non-acidic comonomer to substitute the alkyl acrylate, alkyl methacrylate, styrene, or substituted styrene of the polymer. Examples include acrylonitrile, vinyl acetate, and acrylamide. However, since complete combustion becomes more difficult in these cases, it is preferred to use such monomer at less than approximately 25 wt % of the total amount of the organic binder. A single copolymer or a mixture of copolymers can be used as the organic binder as long as the above-mentioned various conditions are satisfied. It is also possible to add a small amount of other organic polymeric binder in addition to the copolymer. Examples of such organic polymeric binder include polyolefins such as polyethylene, polypropylene, polybutylene, polyisobutylene, ethylene-propylene copolymer, and polyether as a lower alkylene oxide polymer such as polyethylene oxide.

These polymers can be manufactured by means of the solution polymerization technology that is commonly used in the field of acrylic ester polymerization.

Typically, the acidic acrylic ester polymer described above can be manufactured in the following manner. Specifically, a α- or β-ethylenically unsaturated acid (acidic comonomer) is mixed with one or more types of copolymerizable vinyl monomers (non-acidic comonomer) in an organic solvent with a relatively low boiling point (75 through 150° C.) to obtain a 10 through 60% monomer mixture solution. Next, a polymerization catalyst is added into thus obtained monomer to perform polymerization. Then, the thus obtained mixture is heated to a solvent reflux temperature under normal pressure. After polymerization reaction is practically completed, a generated acidic polymer solution is cooled to room temperature. A sample is recovered, and the viscosity, molecular weight, and acid equivalent of the polymer are measured.

The above-mentioned acid-containing organic binder has a molecular weight of less than 50,000, preferably less than 25,000, and more preferably less than 15,000.

When the electrode paste is applied by means of screen printing, it is preferred that the Tg (glass transition temperature) of the organic binder exceed 90° C.

When the electrode paste is dried at a temperature of, normally, 90° C., or lower after screen printing is performed, and if the Tg value is equal to or lower than this temperature, the viscosity of the paste usually becomes extremely high. If a method other than screen printing is used to perform application, a substance having a lower Tg value can be adopted.

The organic binder is usually present in an amount of 5 through 45 wt % of the total amount of dried electrode paste.

### (E) Solvent

The electrode paste of the present invention contains an organic medium as the solvent. The main purpose of using an organic medium is to cause the dispersion of finely pulverized solid content of the paste to function as a medium that can be easily applied ceramics or other substrates. Therefore, first of all, the organic medium must be able to disperse the solid content while maintaining proper stability thereof. Secondly, the rheology characteristics of the organic medium must provide the dispersion with excellent coating characteristics.

The organic medium may be of a single component or a mixture of a plurality of organic media. The organic medium is properly selected so that the polymer and other organic components can be completely dissolved in the organic medium. Preferably, the organic medium is properly selected so that it does not react with other components in the paste. The selected organic medium is preferred to have sufficiently high volatility so that it can evaporate from the dispersion even if coated at a relatively low temperature under atmospheric pressure. However, the organic medium is preferred not to be so volatile that the paste dries rapidly on the screen at ordinary room temperature during the printing operation. The preferable organic medium to be used for the electrode paste has a normal-pressure boiling point lower than 300° C. or preferably lower than 250° C. Examples of such organic medium include aliphatic alcohols, acetic esters, propionic esters, or the esters of the above-mentioned alcohols; pine resin, α- or β-terpineol, a mixture thereof, or other terpinenes; ethylene glycol, ethylene glycol monobutyl ether, butyl cellosolve acetate, or other esters of ethylene glycols; butyl carbitol, butyl carbitol acetate, carbitol acetate, or other carbitol esters; Texanol (2,2,4-trimethyl-1,3-pentanediol monoisobutyrate), and other appropriate organic media.

In addition to the above-mentioned necessary components, the electrode paste of the present invention can contain the following optional substances.

### (F) Photoinitiator

A preferred photoinitiator is thermally inactive but generates free radicals when exposed to chemical rays at a temperature of 185° C. or lower. Such photoinitiator includes a substituted or non-substituted polynuclear quinone, which is a compound having two intramolecular rings in a conjugated carbon ring. Examples include 9,10-anthraquinone, 2-methyl anthraquinone, 2-ethyl anthraquinone, 2-t-butyl anthraquinone, octamethyl anthraquinone, 1,4-naphthoquinone, 9,10-phenanthrenequinone, benzo[a]anthracene-7,12-dione, 2,3-naphthacene-5,12-dione, 2-methyl-1,4-naphthoquinone, 1,4-dimethyl anthraquinone, 2,3-dimethyl anthraquinone, 2-phenyl anthraquinone, 2,3-diphenyl anthraquinone, retene quinone, 7,8,9,10-tetrahydronaphthacene-5,12-dione, and 1,2,3,4-tetrahydrobenzo[a]anthracene-7,12-dione. Other useful photoinitiators are disclosed in U.S. Pat. No. 2,760,863 (however, some of these photoinitiators are thermally active even at a low temperature of 85° C.; they are vicinal ketaldonyl alcohols, such as benzoin or pivaloin; methyl and ethyl ethers of benzoin or other acyloin ethers; α-methyl benzoin, α-allyl benzoin, α-phenyl benzoin, thioxanthone and derivatives thereof, and hydrocarbon-substituted aromatic acyloins containing hydrogen donors).

Photoreducing dyes and reducing agents can be used as the photoinitiator. Examples include those disclosed in U.S. Pat. No. 2,850,445, U.S. Pat. No. 2,875,047, U.S. Pat. No. 309,796, U.S. Pat. No. 3,074,974, U.S. Pat. No. 3,097,097, and U.S. Pat. No. 3,145,104, phenazine, oxazine, and quinones, such as Michler's ketone, ethyl Michler's ketone, benzophenone and the like, 2,4,5-triphenyl imidazoyl dimer formed with a hydrogen donor containing a leuco dye, and mixtures thereof (disclosed in U.S. Pat. No. 3,427,161, U.S. Pat. No. 3,479,185, and U.S. Pat. No. 3,549,367). Also, the sensitizer disclosed in U.S. Pat. No. 4,162,162 can be used together with the photoinitiator and photoinhibitor. The photoinitiator or photoinitiator system is present in an amount of 0.05 through 10 wt % based on the total amount of a dried photopolymerizable layer.

### (G) Photocurable Monomer

The photocurable monomer component that can be used in the present invention contains at least one type of addition polymerizable ethylenically unsaturated compound having at least one polymerizable ethylene group.

Such a compound can start polymer formation, depending on the presence of free radicals, and perform chain-extending addition polymerization. This monomer compound has a non-gas form, that is, it has a boiling point higher than 100° C. and has the effect of providing plasticity to the organic polymeric binder.

Preferable monomers that can be used either alone or in combination with other monomers include t-butyl(meth)acrylate, 1,5-pentanediol di(meth)acrylate, N,N-dimethyl aminoethyl(meth)acrylate, ethylene glycol di(meth)acrylate, 1,4-butanediol di(meth)acrylate, diethylene glycol di(meth)acrylate, hexamethylene glycol di(meth)acrylate, 1,3-propanediol di(meth)acrylate, decamethylene glycol di(meth)acrylate, 1,4-cyclohexane diol di(meth)acrylate, 2,2-dimethylolpropane di(meth)acrylate, glycerol di(meth)acrylate, tripropylene glycol di(meth)acrylate, glycerol tri(meth)acrylate, trimethylolpropane tri(meth)acrylate, compounds disclosed in U.S. Pat. No. 3,380,381, 2,2-di(p-hydroxyphenyl)-propane di(meth)acrylate, pentaerythritol tetra(meth)acrylate, triethylene glycol diacrylate, polyoxyethyl-1,2-di-(p-hydroxyethyl)propane dimethacrylate, bisphenol A di-[3-(meth)acryloxy-2-hydroxypropyl]ether, bisphenol A di-[2-(meth)acryloxyethyle]ether, 1,4-butanediol di-(3-methacryloxy-2-hydroxypropyl)ether, triethylene glycol dimethacrylate, polyoxypropyl trimethyrol propane triacrylate, butylene glycol di(meth)acrylate, 1,2,4-butanediol tri(meth)acrylate, 2,2,4-trimethyl-1,3-pentanediol di(meth)acrylate, 1-phenylethylene-1,2-dimethacrylate, diallyl fumarate, styrene, 1,4-benzenediol dimethacrylate, 1,4-diisopropenyl benzene, and 1,3,5-triisopropenyl benzene (here, “(meth)acrylate” means both “acrylate” and “methacrylate”).

Ethyleneiacally unsaturated compounds with a molecular weight of at least 300 is also useful. Examples include O₂ through O₁₅ alkylene glycol or polyalkylene glycols having 1 through 10 ether bonds, or the compounds disclosed in U.S. Pat. No. 2,927,022, such as the alkylene or polyalkylene glycol diacrylate produced from compounds having addition polymerizable ethylene bonds, especially when they are present as terminal groups.

Other useful monomers are disclosed in U.S. Pat. No. 5,032,490.

Preferable monomers include polyoxyethylated trimethylolpropane tri(meth)acrylate, ethylated pentaerythritol triacrylate, trimethylolpropanetri(meth)acrylate, dipentaerythritol monohydroxy pentacrylate, and 1,10-decanediol dimethacrylate.

Other preferable monomers include monohydroxypolycaprolactone monoacrylate, polyethylene glycol diacrylate (with approximately 200 molecular weight), and polyethylene glycol dimethacrylate (with approximately 400 molecular weight). The unsaturated monomer component is present in an amount of 1 through 20 wt % based on the total weight of the dried photopolymerizable layer.

### (H) Additional Components

Dispersants, stabilizers, plasticizers, release agents, stripping agents, anti-foaming agents, lubricants, and other additional components that are well known in this field can also be added into the paste. General examples of the proper substances are disclosed in U.S. Pat. No. 532,490.

The electrode paste of the present invention can be used as a black electrode in a PDP having a two-layer structure constituted by a black electrode and a white electrode. In this case, a bus conductor paste described hereinafter can be used as the white electrode. It is noted that in the present invention, the electrode obtained from the bus conductor paste is called “white electrode,” while the electrode formed from the electrode paste having the abovementioned black pigment is called “black electrode.” However, the color of the white electrode itself is not necessarily white.

### (I) Bus Conductor Paste (White Electrode Paste)

The bus conductor paste used in the present invention is a photosensitive thick film conductor paste that is commercially available. The preferred paste to be used in the present invention includes silver particles, UV-polymerizable carrier and glass frit.

The conductive phase is the main component of the abovementioned bus conductor paste, typically comprising silver particles with a particle diameter of 0.05 through 20 μm (microns) in a random or thin flake shape. When a UV-polymerizable medium is used together with the paste, it is preferred that the silver particles have a particle diameter of 0.3 through 10 microns. A preferred paste preferably contains 66 wt % of silver particles based on the overall thick film paste including these silver particles. In this case, the surface area of the silver particles is 0.34 m²/g.

The silver conductor paste for forming a bus electrode (bus conductor paste) contains 1 through 10 wt % of refractory materials that do not form glass or a precursor thereof, the materials being inorganic particles that are finely pulverized. Examples of such materials include aluminum oxide, copper oxide, cadmium oxide, gadolinium oxide, zirconium oxide, cobalt/iron/chromium oxide, aluminum, and copper. These oxides or the precursors thereof have a particle diameter of 0.05 through 44 microns, and at least 80 wt % of these particles have a particle diameter of 0.1 through 5 microns. The bus conductor paste also contains 5 through 20 wt % of a glass frit having a softening point of 325 through 600° C. As the preferred glass frit, there is a borosilicate glass, but more preferred paste has the following compositions (mole %): PbO (53.1), B₂O₃ (2.9), SiO₂ (29.0), TiO₂ (3.0), ZrO₂ (3.0), ZnO (2.0), Na₂O (3.0), and CdO (4.0). Such glass frit and proper additive are processed so that the fired metal components having fine lines do not react, dissolve, become damaged, or lose the viscosity thereof to the black electrode below the metal components, even if the metal components are immersed in covering agent, molten to 600° C., for one hour. In addition, the abovementioned lead-free glass frit can be used as the glass frit.

The bus conductor paste may also contain 10 through 30 wt % of a photosensitive medium in which the abovementioned particulate materials are dispersed. Examples of such a photosensitive medium are polymethyl methacrylate and a polyfunctional monomer solution. This monomer is preferred to be selected from those with a low volatility for minimizing evaporation during preparation of the bus conductor paste and printing/drying process before performing UV curing. The photosensitive medium also contains a solvent and UV initiator. The preferred UV-polymerizable medium includes a polymer based on methyl methacrylate/ethyl acrylate in a 95/5 ratio (weight based). The silver conductor paste described above is processed so as to obtain a free-flowing paste having a viscosity of 50 through 200 Pascal seconds (Pa·s).

Suitable solvents for such a medium are, but not limited to, butyl Carbitol acetate and β-terpineol. Also, this medium can additionally include dispersants, stabilizers, and the like.

A covering agent paste containing 85 parts of glass frits (composition of mole %: PbO, 68.2; SiO₂, 12.0; B₂O₃, 14.1; CdO, 5.7; softening point 480° C.) and 14 parts of ethyl cellulose carriers may be applied to such a silver conductor electrode. The coated electrode composite obtained in this manner is useful in manufacturing an AC PDP.

### <Application>

The paste of the present invention can be mixed with the abovementioned photosensitive material to obtain a photosensitive paste. Such photosensitive paste can be used in various applications including flat panel display applications.

When the electrode paste of the present invention is used as a conductive material, this paste can be formed on various substrates, such as a dielectric layer or a glass substrate (for example, a bare glass panel).

### <Flat Panel Display Applications>

The present invention includes black electrodes formed from the electrode paste described above. The black electrodes of the present invention can be preferably used in flat panel display applications, particularly in alternating-current plasma display panel (AC PDP) devices. The black electrodes can be formed between a device substrate and a conductor electrode array.

In one embodiment, the electrode of the present invention is used in AC PDP applications, as described hereinafter. It is understood that the electrode paste and electrodes of the present invention can be used in other flat panel display applications and that the description of the AC PDP devices is not intended to limit the present invention. An example of the black electrodes of the present invention used in an AC PDP is described below. This description includes a single-layer bus electrode of a black electrode on a substrate, and two-layer bus electrodes having a black electrode and a white electrode. Also, a method for creating an AC PDP device is described briefly.

The AC PDP device consists of front and back dielectric substrates with a gap therebetween, and an electrode array containing parallel first and second electrode composite groups in a discharge space filled with ionization gas. The first and second electrode composite groups face each other perpendicularly with the discharge space in the middle. A certain electrode pattern is formed on the surface of the dielectric substrate, and a dielectric material is coated on the electrode array on at least one side of the dielectric substrate. In this device, the electrode composite on at least the front dielectric substrate is fitted with the conductor electrode array group connected to the bus conductor on the same substrate, and the black electrode of the present invention is formed between the abovementioned substrate and the above-mentioned conductor electrode array.

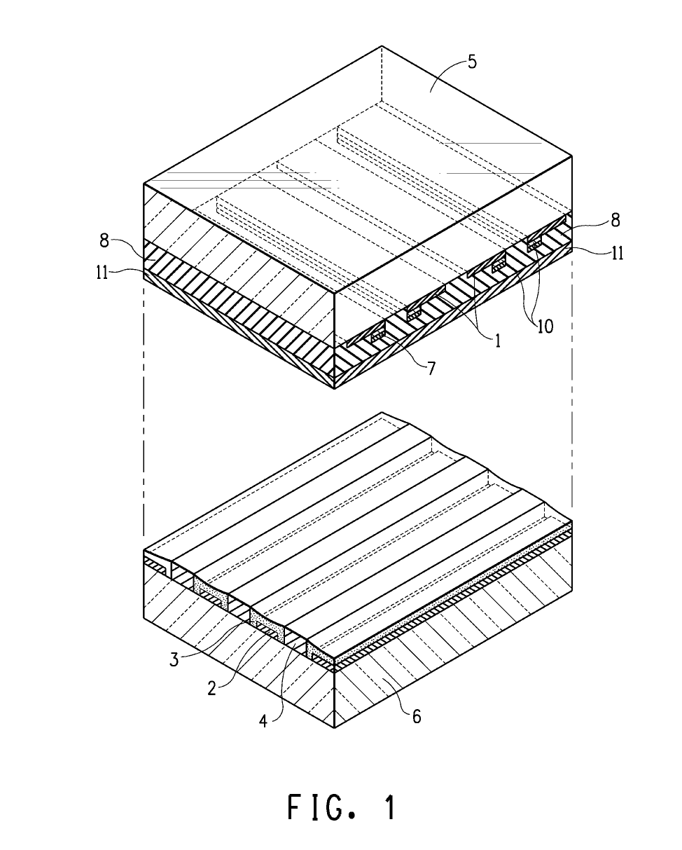

FIG. 1 shows a specific structure of the AC PDP device. FIG. 1 shows the abovementioned two-layer AC PDP device in which the black electrode of the present invention is used. As shown in FIG. 1, the AC PDP device has the following components: a lower layer transparent electrode 1 formed on a glass substrate 5; a black electrode 10 formed on the transparent electrode 1 (the electrode paste of the present invention is used for the black electrode 10); and a white electrode 7 formed on the black electrode 10 (the white electrode 7 is a photosensitive bus conductor paste containing conductive metal particles obtained from metals selected from Au, Ag, Pd, Pt and Cu or combinations thereof (this has been explained above)). In the present invention the bus electrode constituted by the black electrode and white electrode can be taken as a single-layer bus electrode constituted by the black electrode (using the electrode paste of the present invention containing the conductive particles).

Furthermore, the AC PDP device has the back dielectric substrate 6 facing the front substrate, the discharge space 3 filled with ionization gas, and a second electrode (address electrode) 2 that is parallel to the transparent electrode 1. The discharge space is formed at equal spaces by a cell barrier 4. Also, the transparent electrode 1 and the second electrode 2 face each other perpendicularly with the discharge space 3 in the middle.

The black electrode 10 and the white electrode 7 are exposed to light imagewise by actinic radiation to form a pattern, developed in a basic aqueous solution, and fired at high temperature to remove the organic components and to sinter the inorganic material. The black electrode 10 and the white electrode 7 are patterned using an identical or very similar image. Finally, a fired and highly conductive electrode composite, which appears to be black on the surface of the transparent electrode 1, is obtained. When this electrode composite is placed on the front glass substrate, reflection of external light is suppressed.

In the present invention a bus electrode can be formed by means of a single-layer electrode, which is the black electrode 10 only. In this case, each process may be performed without providing the abovementioned white electrode 7 on the black electrode.

The word “black” used in this specification means a dark color with significant visual contrast against a white background. Therefore, this term is not necessarily limited to “black” which possesses the absence of color. The degree of “blackness” may be measured by means of a colorimeter to determine an L-value. The L-value represents lightness where 100 indicates pure white and 0 indicates pure black. Although shown in FIG. 1, the transparent electrode 1 described hereinafter is not necessary in forming the plasma display device of the present invention.

### (J) Transparent Electrode

The transparent electrode is formed using SnO₂ or ITO by means of chemical vapor deposition or electro-deposition technologies such as ion sputtering or ion plating. The configuration of such transparent electrode and method for forming it are known in the field of the conventional AC PDP technology.

As shown in FIG. 1, the AC PDP of the present invention is based on a glass substrate having a transparent dielectric coating layer (transparency overglaze layer) (TOG) 8 and an MgO coating layer 11 over the patterned and fired metallization.

Next is described in detail the method for creating the bus electrode having both black and white electrodes over an optionally selected transparent electrode on the glass substrate of the front panel of the PDP device.

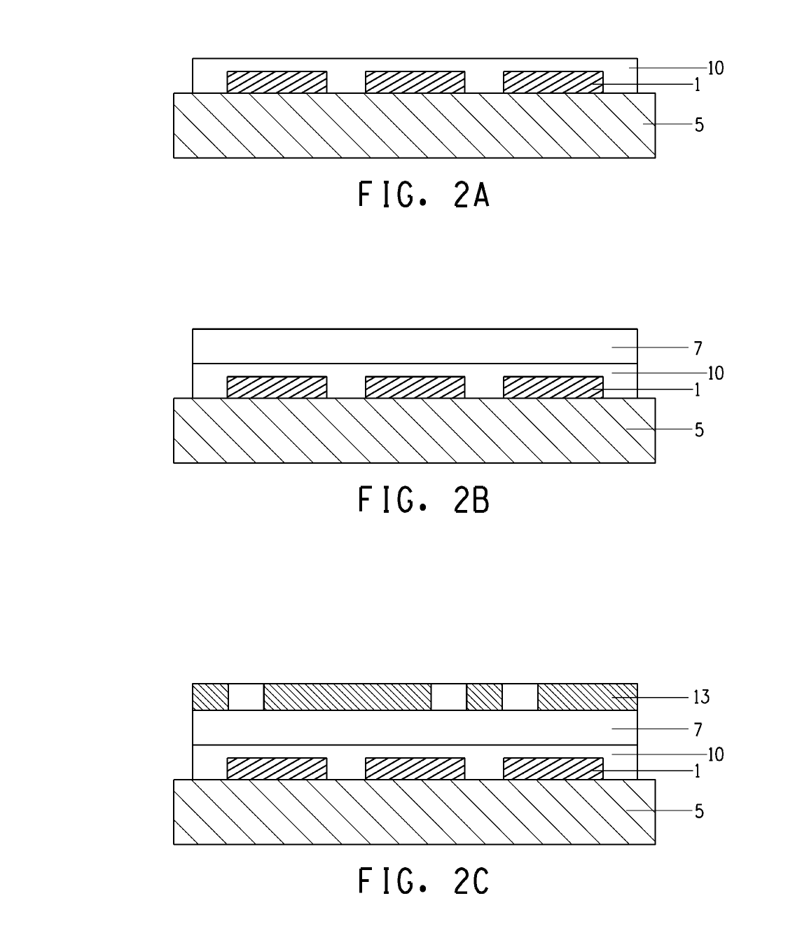

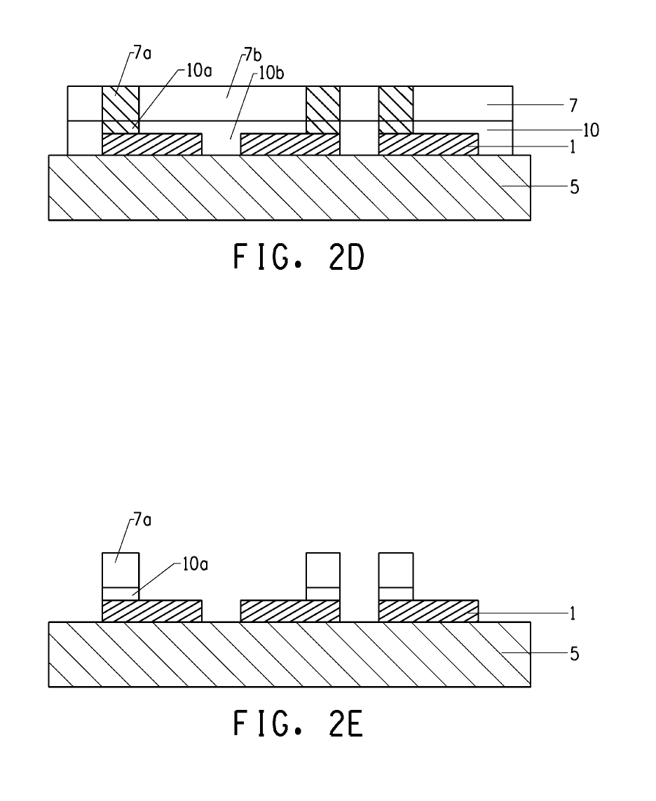

As shown in FIG. 2, the formation method of the bus electrode according to the first embodiment of the present invention involves a series of processes ((A) through (E)).

(A) A process of applying the black electrode paste layer 10 for forming the black electrode of the present invention, which is described above, on the transparent electrode 1 formed using SnO₂ or ITO according to a conventional method known to those skilled in the art, on the glass substrate 5, and then drying the electrode paste layer 10 in a nitrogen or air atmosphere (FIG. 2A).

(B) Applying, to the abovementioned applied electrode paste layer 10, the photosensitive thick film conductor paste (bus conductor paste) 7 for forming the white electrode, and then drying this bus conductor paste layer 7 in a nitrogen or air atmosphere (FIG. 2B).

(C) Imagewise-exposing the abovementioned applied black electrode paste layer 10 and the bus conductor paste layer 7 to actinic radiation (typically a UV source) through a phototool or target 13 having a shape corresponding to a pattern of the black and white electrodes arranged in correlation with the transparent electrodes 1, by means of exposure conditions that yield the correct electrode pattern after development of the electrode paste layer and bus conductor paste layer. (FIG. 2C)

(D) A process of developing the exposed sections 10a, 7a of the respective black electrode paste layer 10 and bus conductor paste layer 7 in a basic aqueous solution, such as a 0.4 wt % sodium carbonate aqueous solution or other alkali aqueous solution. This process removes the unexposed sections 10b, 7b of the respective layers 10, 7. The exposed sections 10a, 7a remain (FIG. 2D). Then, the developed products are dried.

(E) Subsequently to the process (D), the sections are fired at a temperature of 450 through 650° C. in accordance with the material of the substrate, to sinter the inorganic binder and conductive components (FIG. 2E).

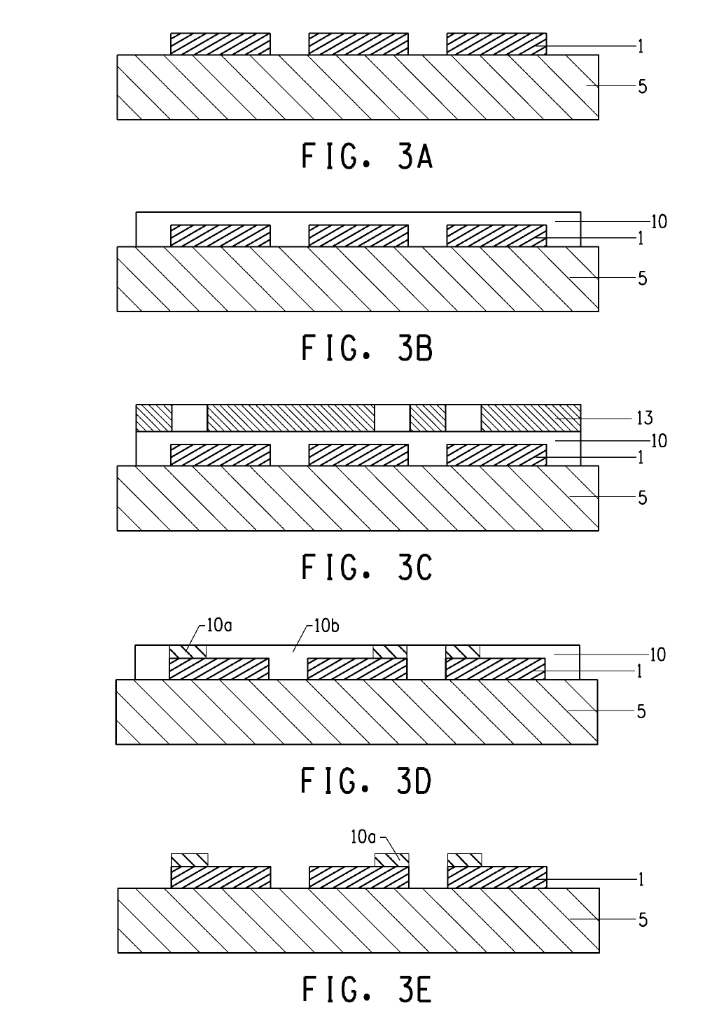

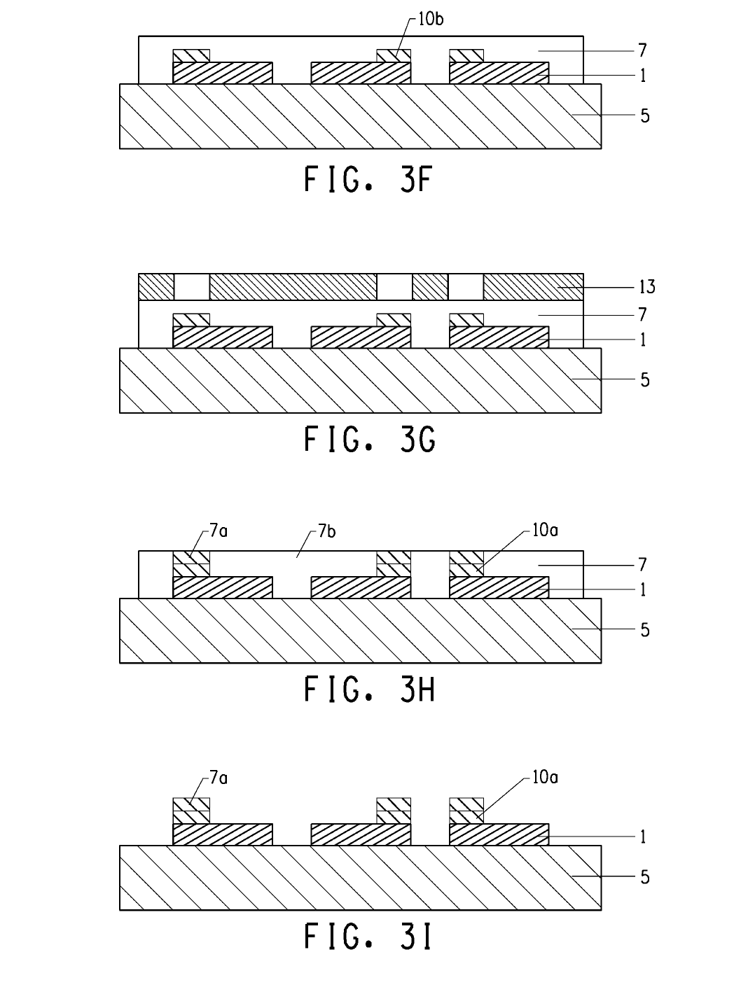

The formation method of the second embodiment of the present invention is described hereinafter with reference to FIGS. 3A-3I. The method of a third embodiment involves a series of processes (a through h).

a. A process of forming the transparent electrode 1 using SnO₂ or ITO according to a conventional method known to those skilled in the art (FIG. 3A), on the glass substrate 5, thereafter applying the black electrode paste layer 10 for forming the black electrode, onto this transparent electrode, and then drying this electrode paste layer 10 in a nitrogen or air atmosphere (FIG. 3B).

b. Imagewise-exposing the abovementioned applied black electrode paste layer 10 to actinic radiation (typically a UV source) through the phototool or target 13 having a shape corresponding to a pattern of the black electrodes arranged in correlation with the transparent electrodes 1, by means of the exposure conditions that yield the correct black electrode pattern after development of the electrode paste layer (FIG. 3C).

c. A process of developing the exposed section 10a of the abovementioned black electrode paste layer 10 in a basic aqueous solution, such as a 0.4 wt % sodium carbonate aqueous solution or other alkali aqueous solution, in order to remove the unexposed section 10b of the layer 10 (FIG. 3D). Then, the developed product is dried.

d. Subsequently to the process c, these sections are fired at a temperature of 450 through 650° C. in accordance with the material of the substrate, to sinter the inorganic binder and conductive components (FIG. 3E).

e. A process of applying the bus conductor paste layer 7 for forming the white electrode to the black electrode 10a of the fired and patterned section 10a of the black electrode paste layer 10, and then drying it in a nitrogen or air atmosphere (FIG. 3F). The bus conductor paste is described above.

f. Imagewise-exposing the abovementioned applied bus conductor paste layer 7 to actinic radiation (typically a UV source) through the phototool or target 13 having a shape corresponding to a pattern of the bus electrodes arranged in correlation with the transparent electrodes 1 and black electrode 10a, by means of the exposure conditions that yield the correct electrode pattern after development of the bus conductor paste layer (FIG. 3G).

g. A process of developing the exposed section 7a of the bus conductor paste layer 7 in a basic aqueous solution, such as a 0.4 wt % sodium carbonate aqueous solution or other alkali aqueous solution, in order to remove the unexposed section 7b of the layer 7 (FIG. 3H). Then, the developed product is dried.

h. Subsequently to the process g, these parts are then fired at a temperature of 450 through 650° C. in accordance with the material of the substrate, to sinter the inorganic binder and conductive components (FIG. 3I).

Next is described a method of creating a single-layer black bus electrode (third embodiment) on an optionally selected transparent electrode on the glass substrate of the front panel of the PDP device.

The third embodiment involves a series of processes ((i) through (iv)) described hereinafter.

(i) A process of loading a black electrode paste on a substrate. This black electrode paste is the black electrode paste of the present invention, which contains the conductive metals described above.

(ii) A process of setting an electrode pattern by imagewise-exposing the black electrode paste by means of actinic radiation.

(iii) A process of developing the exposed black electrode paste by means of a basic aqueous solution in order to remove the area that is not exposed to actinic radiation.

(iv) A process of firing the developed black electrode paste.

The formation method of the third embodiment of the present invention involves a series of processes a′ through d′ described hereinafter, but the series of processes are the same as the processes (a through d) in the series of processes (a through h) of the second embodiment described above.

a′. A process of applying the black electrode paste layer 10 for forming a black electrode, onto the transparent electrode 1 formed using SnO₂ or ITO according to a conventional method known to those skilled in the art, on the glass substrate 5, and then drying this electrode paste layer 10 in a nitrogen or air atmosphere (FIG. 3A).

b′. Imagewise-exposing the abovementioned applied black electrode paste layer 10 to actinic radiation (typically a UV source) through the phototool or target 13 having a shape corresponding to a pattern of the black electrodes arranged in correlation with the transparent electrodes 1, by means of the exposure conditions that yield the correct black electrode pattern after development of the electrode paste layer. (FIG. 3B).

c′. A process of developing the exposed section 10a of the abovementioned black electrode paste layer 10 in a basic aqueous solution, such as a 0.4 wt % sodium carbonate aqueous solution or other alkali aqueous solution, in order to remove the unexposed section 10b of the layer 10 (FIG. 3C). Then, the developed product is dried.

d′. Subsequently to the process c′, these sections are fired at a temperature of 450 through 650° C. in accordance with the material of the substrate, to sinter the inorganic binder and conductive components (FIG. 3D).

The front glass substrate assembly that is formed in the manner described above can be used in the AC PDP. For example, referring back to FIG. 1, after forming the transparent electrode 1 in relation to the black electrode 10 and bus electrode 7 on the front glass substrate 5, the front glass substrate assembly is covered with the dielectric layer 8, and then coated with the MgO layer 11. Next, the front glass substrate 5 is combined with the back glass substrate 6. The cell barriers 4 are formed on the back glass 6, along with several display cells that are screen-printed by means of a fluorescent substance. The electrode formed on the front substrate assembly is perpendicular to the address electrode 2 formed on the back glass substrate. The discharge space formed between the front glass substrate 5 and the back glass substrate 6 is sealed with a glass sealant and at the same time a discharge gas mixture is sealed into the space. The AC PDP device is assembled in such a manner.

### Examples

The embodiments of the present invention are described hereinafter in more detail. The embodiments described hereinafter are examples and are not intended to limit the present invention.

<Preparation of Electrode Paste>

(i) Black Electrode Paste in the Case of Single-Layer Bus Electrode

(A) Preparation of Organic Medium

Texanol (2,2,4-trimethyl-1,3-pentanediol monoisobutyrate) as the solvent and acrylic polymer binder having a molecular weight of 30,000 were mixed, stirred, and heated to 100° C. The heating and stirring were performed to complete dissolution of the binder polymer. The resulting solution was cooled to 75° C., and added with photopolymerizable initiators such as Irgacure 907 and 651 manufactured by Chiba Specialty Chemicals, and a stabilizer such as TAOBN: 1,4,4-trimethyl-2,3-diazabicyclo[3.2.2]-non-2-en-N,N-dioxide. This mixture was stirred at 75° C. until all of the solid materials were dissolved. This solution was passed through a 40 μm-mesh filter and then cooled.

(B) Preparation of Paste

The paste was prepared by mixing 24.19 wt % of the abovementioned organic medium with a photopolymerizable monomer composed of TMPEOTA (trimethyl-propane ethoxy triacrylate), TMPPOTA (propoxylated trimethylolpropane triacrylate), and BSAF Corporation's Lanomer LR8967 (polyethyl acrylate oligomer), and other organic components such as 0.12 wt % of butylated hydroxytoluene, 0.11 wt % of malonic acid and 0.12 wt % of Byk-Chemie Corporation's BYK085, in a mixing vessel under yellow light. Then, the inorganic materials such as cobalt oxide (CO₃O₄) and copper-chromium-cobalt composite oxide (Cr—Cu—Co—O), as well as spherical particles of Ag, which are conductive particles, and glass frit were added to this mixture of organic components. The ratio between cobalt oxide (CO₃O₄) and copper-chromium-cobalt composite oxide (Cr—Cu—Co—O) is as shown in Table 1 below. The entire paste was mixed until the inorganic particles were wetted with the organic materials. This mixture was roll-milled using a 3-roll mill. The resulting paste was passed through a 20 μm-mesh filter. At this point, the viscosity of the paste was adjusted by means of the solvent Texanol, whereby a viscosity that is most suitable for print application was obtained.

TABLE 1

| Component | Ex. 1 | Ex. 2 | Ex. 3 | Ex. 4 | Ex. 5 |
|---|---|---|---|---|---|
| Co₃O₄ | 0 | 20 | 50 | 80 | 100 |
| Cr—Cu—Co—O | 100 | 80 | 50 | 20 | 0 |

(ii) Black Electrode Paste in the Case of Bus Electrode Having Two Layers of Black and White Electrodes

(A) Preparation of Organic Medium

Texanol (2,2,4-trimethyl-1,3-pentanediol monoisobutyrate) as the solvent and acrylic polymer binder having a molecular weight of 30,000 were mixed, stirred, and heated to 100° C. The heating and stirring were performed to complete dissolution of the binder polymer. The resulting solution was cooled to 75° C., and added with photopolymerizable initiators such as Irgacure 907 and 651 manufactured by Chiba Specialty Chemicals, and a stabilizer such as TAOBN: 1,4,4-trimethyl-2,3-diazabicyclo[3.2.2]-non-2-en-N,N-dioxide. This mixture was stirred at 75° C. until all of the solid materials were dissolved. This solution was passed through a 40 μm-mesh filter and then cooled.

(B) Preparation of Black Electrode Paste

The paste was prepared by mixing 36.19 wt % of the abovementioned organic medium with a photopolymerizable monomer composed of TMPEOTA (trimethyl-propane ethoxy triacrylate) and BSAF Corporation's Lanomer LR8967 (polyethyl acrylate oligomer), and other organic components such as 0.12 wt % of butylated hydroxytoluene, 0.46 wt % of malonic acid and 0.12 wt % of Byk-Chemie Corporation's BYK085, in a mixing vessel under yellow light. Then, the inorganic materials such as cobalt oxide (CO₃O₄) and copper-chromium-cobalt composite oxide (Cr—Cu—Co—O), and glass frit were added to this mixture of organic components. The ratio between cobalt oxide (CO₃O₄) and copper-chromium-cobalt composite oxide (Cr—Cu—Co—O) is as shown in Table 1 above. The entire paste was mixed until the inorganic particles were wetted with the organic materials. This mixture was roll-milled using the 3-roll mill. The resulting paste was passed through a 20 μm-mesh filter. At this point, the viscosity of the paste was adjusted by means of the solvent Texanol, whereby a viscosity that is most suitable for print application was obtained.

(C) Preparation Method of Ag Paste (Bus Conductor Paste)

The paste was prepared by mixing 24.19 wt % of the abovementioned organic medium with a photopolymerizable monomer composed of TMPPOTA (propoxylated trimethylolpropane triacrylate) and BSAF Corporation's Lanomer LR8967 (polyethyl acrylate oligomer), and other organic components such as 0.12 wt % of butylated hydroxytoluene, 0.11 wt % of malonic acid and 0.12 wt % of Byk-Chemie Corporation's BYK085, in a mixing vessel under yellow light. Then, the inorganic materials such as spherical particles of Ag, which are conductive particles, and glass frit were added to this mixture of organic components. The entire paste was mixed until the inorganic particles were wetted with the organic materials. This mixture was roll-milled using the 3-roll mill. The resulting paste was passed through the 20-μm-mesh filter. At this point, the viscosity of the paste was adjusted by means of the solvent Texanol, whereby a viscosity that is most suitable for print application was obtained.

(iii) Preparation Conditions of the Electrodes

(A) Manufacturing Conditions

When preparing the paste or manufacturing the parts, care was taken to prevent dirt contamination, since such contamination can lead to defects.

(A-1) Formation of Black Electrode

The composition and, depending on the desired thickness after drying, the paste were adhered to a glass substrate by performing screen printing using a 200 through 400-mesh screen. The black paste of the examples was adhered to the glass substrate by performing screen printing using a 350-mesh polyester screen. The part to be tested as a two-layer structure part was prepared on the glass substrate on which the transparent electrode (thin-film ITO) is formed. The part to be tested as a single-layer (black only) was prepared on the glass substrate on which the ITO coating film is not formed. Next, these parts ware dried at 100° C. in a warm-air circulating oven for 20 minutes, whereby a black electrode having a dry film thickness of 2 through 6 μm was formed.

Next, the part to be tested as a single-layer (black only) structure part was fired.

Then, the part to be tested as a two-layer structure part was processed in the manner described hereinafter.

(A-2) Formation of Bus Conductor Electrode (White Electrode)

Subsequently, the abovementioned Ag paste was applied by performing screen printing using a 325-mesh screen made of stainless steel.

This part was dried again at 100° C. for 20 minutes. The thickness of the dry film was 6 through 10 μm. The thickness of the dried two-layer structure part was 10 through 16 μm.

(A-3) UV Pattern Exposure

The part with the two layers was exposed to a collimated UV light source through a phototool (illuminance: 5 through 20 mW/cm²; exposure energy: 400 mj/cm²; non-contact exposure, gap between mask and coating: 150 μm).

(A-4) Development

The exposed part was placed on a conveyor and introduced into a spray developer containing a 0.4 wt %-sodium carbonate aqueous solution as the developer solution. The temperature of the developer solution was maintained at 30° C., and sprayed at 10 through 20 psi. This part was subjected to development for 20 seconds (3 to 4 times longer than the time required for scouring TTC). The developed part was dried by blowing off the excess water, in a forced air stream.

(A-5) Firing

The dried part was fired in an air atmosphere in a belt furnace using a profile having a total length of 1.0 hour, to a peak temperature of 580° C.

(A-6) Coating TOG

Next, the TOG paste was applied by performing screen printing using a 250-mesh screen made of stainless steel. This part was dried again at 100° C. for 20 minutes. The resulting part was fired in an air atmosphere in the belt furnace using a profile having a total length of 2.0 hours, to a peak temperature of 580° C.

<Evaluation>

L-Value of Two Layer of Ag/Black

After firing was performed, the blackness viewed from the back of the glass substrate is measured mechanically. For blackness, the color (L*) was measured using an optical sensor SZ and a color measurement system S80 of Nippon Denshoku Kogyo, wherein calibration was performed using a standard white plate, with 0 being pure black and 100 pure white. It is noted that L* represents lightness where 100 indicates pure white and 0 indicates pure black.

L-Value of Single Layer (Black Only)

An ITO film-free insulation glass substrate was coated with a black electrode as in (A-1) described above, and then dried. Each of the processes (A-2), (A-3) and (A-4) is omitted, and the dry black electrode thus obtained is fired under the same conditions as those of the process (A-5) to form a single solid-fired black electrode layer. After the firing, the resulting substrate was subjected to the process (A-6) according to need, and the blackness viewed from the back of the glass substrate was measured by the color meter of Nippon Denshoku or the Minolta CR-300 colorimeter under the conditions used for the abovementioned L-value of the two layers Ag/black. At this moment, 0 indicated pure black and 100 indicated pure white.

Black Resistance (Ω)

In this evaluation the resistance of the black electrode was measured. This method is used to confirm the conductive property of the fired black layer. Using the test part described above (L-value of the single layer), the resistance of the black electrode fired film was measured by means of a resistance meter having a probe distance of approximately 4 cm. Using this device, the maximum resistance that can be measured is 1 GΩ.

### Results

### Two Layers

| | | | | |
|---|---|---|---|---|
| | Cr—Cu—Co—O | Co₃O₄ | | |
| Examples | rates/% | rates/% | L-color | Sheet-R |

Bare Before TOG

| | | | | |
|---|---|---|---|---|
| 1 | 0 | 100 | 20.2 | 8.38 |
| 2 | 20 | 80 | 19.48 | 8.22 |
| 3 | 50 | 50 | 18.25 | 8.47 |
| 4 | 80 | 20 | 17.21 | 8.45 |
| 5 | 100 | 0 | 18.36 | 8.16 |

Bare After TOG

| | | | | |
|---|---|---|---|---|
| 1 | 0 | 100 | 15.95 | 7.501 |
| 2 | 20 | 80 | 15.52 | 7.34 |
| 3 | 50 | 50 | 14.61 | 7.64 |
| 4 | 80 | 20 | 13.38 | 7.656 |
| 5 | 100 | 0 | 14.56 | 7.4344 |

### Single Layer

| | | | | |
|---|---|---|---|---|
| | Cr—Cu—Co—O | Co₃O₄ | | |
| Examples | rates/% | rates/% | L-color | Sheet-R |

Bare Before TOG

| | | | | |
|---|---|---|---|---|
| 1 | 0 | 100 | 53 | 10.5 |
| 2 | 20 | 80 | 51.2 | 10.3 |
| 3 | 50 | 50 | 48.7 | 9.5 |
| 4 | 80 | 20 | 47.8 | 9.4 |
| 5 | 100 | 0 | 50.1 | 10.1 |

Bare After TOG

| | | | | |
|---|---|---|---|---|
| 1 | 0 | 100 | 41.2 | 10.4 |
| 2 | 20 | 80 | 38.1 | 10.2 |
| 3 | 50 | 50 | 35.6 | 9.4 |
| 4 | 80 | 20 | 34.5 | 9.1 |
| 5 | 100 | 0 | 37.9 | 10.2 |

According to the results shown above, the electrode paste of the present invention shows the same tendency between the single-layer and two-layer bus electrodes. By containing the CO₃O₄ and Cr—Cu—Co oxide as the black pigment, the electrode paste of the present invention can provide higher blackness and lower resistance value, compared to the single Cr—Cu—Co oxide and single CO₃O₄.

What is claimed is:

1. A single-layer bus electrode formed on a front panel of a plasma display panel, comprising:
a conductive metal; and
a black pigment comprising copper-chromium-cobalt composite oxide (Cr—Cu—Co—O) and cobalt oxide (CO₃O₄), wherein the copper-chromium-cobalt composite oxide is 45 to 90 wt % based on the total amount of the copper-chromium-cobalt composite oxide and the cobalt oxide.

2. A single-layer bus electrode according to claim 1, wherein the copper-chromium-cobalt composite oxide is 50 to 85 wt % based on the total amount of the copper-chromium-cobalt composite oxide and the cobalt oxide.

3. A single-layer bus electrode according to claim 1, wherein the conductive metal is selected from the group consisting of gold, silver, platinum, palladium, copper and a mixture thereof.

4. A front panel of a plasma display panel, comprising:
a glass substrate;
a transparent electrode formed on the glass substrate;
the single-layer bus electrode of claim 1 formed on the transparent electrode in direct contact with the transparent electrode; and
a transparency overglaze layer (TOG) formed on the single-layer bus electrode in direct contact with the single-layer bus electrode.
